(19) United States
(12) Patent Application Publication
(10) Pub. No.: US 2025/0276295 A1
(43) Pub. Date: Sep. 4, 2025

(54) METHOD AND FACILITY FOR THE OXYGEN-ENRICHMENT OF WATER USED FOR ANIMAL WATERING OR FOR IRRIGATION

(71) Applicants: L'Air Liquide, Société Anonyme pour l'Etude et l'Exploitation des Procédés Georges Claude, Paris (FR); Air Liquide France Industrie, Paris (FR)

(72) Inventors: Fanck COUSIN, Saint Brevin les Pins (FR); Dominique IBARRA, Gif-sur-Yvette (FR); Pauline LE DRU, Beaucouzé (FR)

(21) Appl. No.: 19/051,867

(22) Filed: Feb. 12, 2025

(30) Foreign Application Priority Data
Feb. 29, 2024 (FR) FR2402047

(51) Int. Cl. B01F 23/237; C02F 1/68; C02F 103/02

(52) U.S. Cl. CPC B01F 23/237612; C02F 1/68; C02F 2103/02

(57) ABSTRACT

Facility for oxygen-doping of water used to irrigate crops or to water animals (40) comprises an injector (7, 8), a water inlet line (20), at least one gas inlet line (3, 4, 5, 6), at least one source (1, 60) of oxygen or of a gas mixture including oxygen, a tank (17) of water at atmospheric pressure, a pump (9), a coil (10), a water pressure sensor (90), and a water flow sensor (80).

### CROSS REFERENCE TO RELATED APPLICATIONS

This application claims the benefit of priority under 35 U.S.C. § 119 (a) and (b) to French Patent Application No. 2402047, filed Feb. 29, 2024, the entire contents of which are incorporated herein by reference.

### FIELD OF THE INVENTION

The present invention relates to methods and facilities for the oxygen-enrichment of water used for animal watering or for irrigation.

### BACKGROUND

In the field of animal watering, the invention relates notably to poultry farms, pig farms, or rabbit farms.

This description addresses animal farming, followed by irrigation water. It should be remembered here for example that, for a chicken to reach the weight of 1.5 kg, it took approximately 120 days in 1920, approximately 44 days in 1980 and only approximately 33 days in 1998.

According to various studies, experimental surveys in such farms show that, at the same age (49 days), the average weight of a broiler doubled between 1967 and 1996. Furthermore, in recent years, consumer demand has evolved toward less fatty animals and pre-cut poultry meats.

These production objectives have been achieved thanks to the change in nutritional programmes and rearing conditions, associated with the genetic selection of rapid-growth animals, with a low consumption index, low fattening and increased development of the muscle masses.

Genetics, hygiene, prophylaxis and the improvement in rearing conditions have, for the past twenty years, considerably reduced the mortality of poultry on farms.

Nevertheless, the following aspects which appear in all the studies issued on the subject should be taken into account:
rapid body growth increases oxygen requirements and heat production.
the increase in the output of pectoral mass accentuates the imbalance between the development of muscle mass and the development of other tissues, such as the kidney, heart and lungs. In current farms, the change in the growth characteristics is sometimes accompanied by an increase in the frequency of failures of the cardiovascular and respiratory systems, characterized by an increased prevalence of “heat stroke”, “sudden death” syndrome and ascites (accumulation of fluid in the peritoneal cavity).

The studies available in this area can be summarized by the fact that oxygen is a limiting factor which can help explain the frequency of cardiovascular and respiratory diseases in broilers. Comparison of genotypes having variable growth rates shows that the high incidence of ascites and the high growth rate are associated with a low oxygen pressure and a high CO₂ pressure in venous blood. Insufficient oxygen availability thus appears to be a major cause of dysfunction of the cardiovascular and respiratory systems in rapid-growth chickens.

The above demonstrates the need to restore a balance between the metabolic needs imposed by selection for rapid growth and the ability of the respiratory system, which supplies oxygen, to meet them.

One possible approach would be to increase the oxygen content in the environment of the farmed chicken. Unfortunately, intensive farms require strong ventilation in order to evacuate the heat and the humidity produced by the poultry, and thus the oxygen consumption, in order to change from 20.9% to 27% for example, would be prohibitive, making the solution unworkable in economic terms.

The applicant has carried out numerous studies on this question, and reference may be made notably to the document EP-3 709 793 (WO2019097142), which proposed a novel facility for the oxygen-doping of water for watering such livestock.

The applicant subsequently proposed, in document FR-3 134 682, improvements to the facility proposed in that earlier document EP'793.

To clarify the current situation in this technical field, reference may be made firstly to the appended FIG. 1 which illustrates the contents of a watering facility in accordance with the earlier document WO2019/097142 cited above.

The following elements are identified in this FIG. 1:
an injector 61, for example a Venturi injector, for injecting a gas into water;
a water inlet line (“WATER”) and a gas inlet line (“GAS”) arrive at this injector 61, the upstream end of this gas line being in this case connected to a store of oxygen (represented by a cylinder) or of a mixture of gases including oxygen, for example a mixture of 70% oxygen and 30% CO₂.
a pressure-reducing valve 62;
a regulating valve 63 (gas-regulating valve calibrated to inject a chosen amount of gas into the injector);
a coil 64: the length of the coil enables selection of a gas/water contact time, preferably usually greater than 10 seconds, and more preferably usually between 10 and 30 seconds;
a water circulation pump 65: the water pump enables high water-speeds in the coil;
a backpressure regulator 66;
a float valve 67;
a tank of water at atmospheric pressure 68.

This previously proposed facility has already proven successful in limiting capital costs, since it avoids the (expensive) use of an oxygen analyser.

The “WATER” line arriving from the right supplies the bath with “fresh” or new water, thus enabling the tank to be first filled with water before starting; the float valve 67 (for example of the WC water flush type) makes it possible to maintain a constant water level in the tank.

The use of a tank of water at atmospheric pressure simultaneously maintains a low pressure to the watering network and a high pressure in the coil in order to dissolve the oxygen.

The backpressure regulator always maintains the same pressure in the circuit whatever the water consumption.

The oxygen injection system operates when the watering network is supplied with water, and the system is shut off in the event of stoppage.

A “suction water” line leaves from the reservoir and conveys water from the reservoir to the injector; it is thus a mixture of recycled water and of fresh water. In other words, except when the animals are not consuming water, the injector receives 100% recycled water (remember that the animals always consume water; to stop them, the light has to be turned off).

The water can be directed, via the pump 65 and the dissolution coil 64, to the watering zone, passing outside the tank 68, as will have been understood, and through the backpressure regulator 66. The backpressure regulator is also located outside the bath, but the backpressure regulator may have to be positioned in the water of the tank for reasons of space/fit.

As shown in FIG. 1, the facility enables, if necessary, a part of the water coming from the coil to flow into the tank and another part to flow into the watering zone.

The improvements subsequently made by the applicant with document FR-3 134 682 are detailed below with reference to the appended FIG. 2.

The nomenclature of the elements in FIG. 2 is as follows:
1: gas cylinder
2: gas pressure-reducing valve (expanding the gas at a pressure higher than the pressure of the water network)
3: suction-side flowmeter (for regulating the oxygen flow on the suction side of the pump 9)
4: discharge-side flowmeter (for regulating the oxygen flow on the discharge side of the pump 9)
5: suction-side solenoid valve (controlled by activation of the pump and by a flow sensor)
6: discharge-side solenoid valve (controlled by activation of the pump and by a flow sensor and by a level switch with time delay)
7: suction-side Venturi (for injecting gas at a low flow rate into the water on the suction side of the pump without causing cavitation)
8: discharge-side Venturi (for injecting gas into the water on the discharge side of the pump, at the flow rate corresponding to the water supplementing the suction flow)
9: pump (for increasing the pressure of the water and creating a water flow, preferably between 1 m/s and 2.5 m/s)
10: coil (for dissolving the oxygen in the water, with a water flow rate preferably between 1 m/s and 2.5 m/s and a contact time preferably between 10 and 20 seconds)
11: water inlet solenoid valve (for maintaining the water level in the tank and activating the oxygen injection by actuating the reference sign 6)
12: backpressure regulator (for maintaining the water flow rate and therefore the speed in the coil, thereby supplying the desired outlet pressure to the user site)
13: solenoid valve (normally open (NO), for bypassing the system if the pump or control system stops, thereby ensuring that the animals always have water)
14: level switch (for managing the water level in the tank and triggering the high-flow oxygen injection, reference sign 6)
15: water flow regulator, regulating the inlet flow of new water
16: filter
17: water tank
20: fresh water inlet
30: recirculation/bypass
40: water network at the farm
50: watering stations (nipples)

This facility according to the prior art, as shown schematically in FIG. 2, in fact proposes implementing TWO simultaneous injections of oxygen or of a mixture including oxygen:
one upstream of the pump;
and the other downstream of the pump;
   the flow rate of the injection upstream being lower than the flow rate downstream of the pump, the flow rate of gas injected upstream preferably representing between 5% and 25% of the saturation point of pure oxygen in water under the considered conditions, 25% being considered the limit which can cause cavitation, while the flow rate downstream of the pump represents the amount required to supplement the first injection to reach the desired total content value.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates the contents of a watering facility in prior art WO2019/097142;

FIG. 2 illustrates the contents of a watering facility in prior art FR-3 134 682; and

FIG. 3 illustrates a partial schematic view of an exemplary embodiment of a facility for oxygen-enrichment of water used for animal watering or for irrigation in accordance with the present invention.

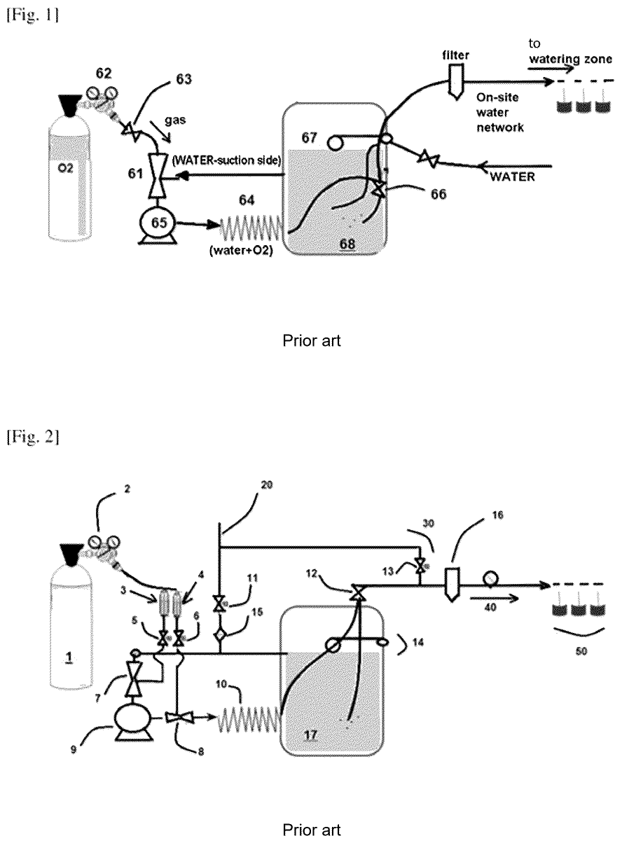

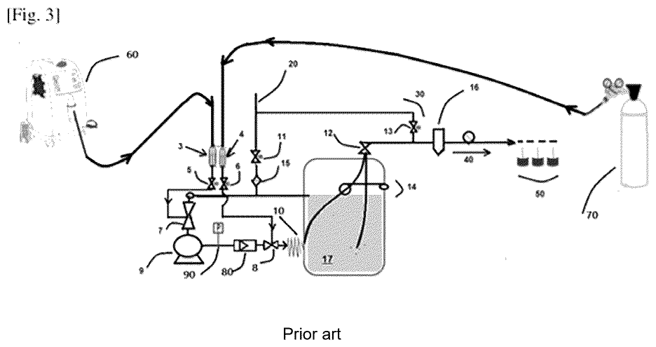

### DETAILED DESCRIPTION OF PREFERRED EMBODIMENTS

Although the whole of the description above is intended to describe the phenomena occurring in the field of animal watering, it should be understood that these systems for doping water with oxygen can also be used for growing crops, notably in greenhouses and without soil, but more generally to any method of growing crops, and notably in a controlled environment: in greenhouses, in cellars, sheltered from light, and without soil, notably using hydroponic, aquaponic, aeroponic, bioponic or other soilless methods.

Thus, crops grown in greenhouses and without soil are discussed below. Such crops are becoming more popular all over the world, in rich and poor countries alike. They are one of the solutions for providing future generations with nutritious healthy food. To do this, they use scarce natural resources such as water and fertilizers in the most efficient way possible.

For example, it is generally considered that one kilo of tomatoes grown in open fields uses about 60 litres of water, while in soilless cultivation in a greenhouse, the water requirement is limited to about 15 litres.

In the case of a latest generation greenhouse, it is even possible to save an additional 4 litres per kilo. These savings are the result of more efficient use of water by controlling the oxygen content of the nutrient solutions.

Oxygen-enrichment of irrigation water for soilless cultivation has been demonstrated to increase the production yield:

Indeed, the reasons why plant roots certainly need water but also need oxygen are well known, and especially the fact that when the oxygen content in the soil is not sufficient, the absorption of water by the plant is limited and the susceptibility of the plant to diseases is increased.

It is also known that oxygen-enrichment of irrigation water using air limits the content to a maximum of 10 mg/L, whereas dissolved-oxygen enrichment using pure oxygen (O₂) makes it possible to reach much higher contents (typically 40 mg/L).

With reference again to document FR-3 134 682, which describes an injection configuration enabling oxygen to be injected from sources, and notably proposes using a standalone (on-site) production source such as oxygen “concentrators”, which are well known and used in the medical field (supplying patients with oxygen-enriched air).

Since the flow rate on the suction side of the pump installed in the facility according to this prior art document is relatively low, this concentrator technology was and remains very well suited to providing such a supply.

Since the work set out in this document FR-3 134 682, the applicant has identified the need to improve this proposal for the implementation of such oxygen concentrators in such facilities, with the following objectives:
to ensure that the oxygen produced is effectively “aspirated” by the pump;
to improve the safety of the system.

The reasons for addressing these technical objectives are set out below.

Indeed, concentrators do not provide sufficient gas pressure to enable injection on the discharge side of a water circulation pump. Concentrators do not deliver a pressure above 1 bar.

A Venturi could be inserted at the outlet of the pump to aspirate the gas, but this functionality is very difficult to implement. The design of a Venturi is very specific to the factors of water flow, water pressure, gas flow, and gas pressure, and a change in characteristics during use jeopardizes the suction process itself.

The principle of a water pump is to aspirate a liquid and to convey it by pressurization. There is therefore suction, and the negative pressure generated by this suction of water can be used to introduce a gas at low or very low pressure.

In terms of safety, it is known to be undesirable to inject too much gas into the pump because the pump may suffer from “cavitation”.

Cavitation is the formation and rapid implosion of gas bubbles in the water as it flows through the pump. Cavitation is a phenomenon caused by boiling water or the saturation of gas in the liquid, and represents an important problem which must be monitored when using pumps and which can have devastating effects on such pumps.

Cavitation causes premature wear, but the introduction of excess gas on the suction side also prevents suction of the water, causing the pump to turn (rotate) in the presence of a gas and to overheat as a result of friction. This situation can therefore become critical, notably in the presence of gases which are not neutral (combustible or oxidizing gases such as oxygen).

There is therefore a proven safety risk if there is too much gas in proportion to the water flow.

Injecting a gas into a pump that has not reached operating speed risks sending too much gas in proportion to the water flow.

A water flow sensor could be used to avoid this risk, but such equipment indicates a flow rate and cannot indicate whether the pump has reached its optimum flow rate.

As detailed below, the present invention proposes an improved implementation of such a concentrator in such a facility for the oxygen-doping of water intended for animal watering or irrigation.

As set out above, the gas should be injected by the concentrator on the suction side of the pump, because the pressure there is lower than the outlet pressure of the generator, bearing in mind that it is not desirable to use a pump (compressor) to pressurize the gas, which represents an additional cost and poses material compatibility issues relating to the oxygen.

A valve could be installed at the generator outlet to create a slight pressure, and therefore without aspirating any air. However, according to the present invention, another solution is preferred, consisting of installing a water pressure sensor downstream (discharge side) of the pump, as well as a water flow sensor, preferably installed on the discharge side of the pump, enabling operation as follows:
When the pump is started, the flow sensor authorizes the concentrator to be activated electrically (as will be clearly apparent to a person skilled in the art, the flow sensor “sees” the activation of the pump more quickly and is therefore able to initiate the electrical activation of the concentrator more quickly).
The pressure at the outlet of the pump then rises to its working pressure and when the pressure at the outlet of the pump rises to a desired pressure setpoint, the pressure sensor then authorizes the opening of a solenoid valve located between the concentrator and the suction side of the pump.
   (The concentrator thus has time to activate before the opening of the solenoid valve, which is controlled by the pressure sensor).

It is preferable to express this pressure setpoint as a % of the maximum pressure generated by the pump, and it is preferable according to the invention to place the setpoint in the range from 50% to 100% of this maximum pressure.

The flow sensor is preferably positioned on the discharge side of the pump, but for reasons of space it may be installed upstream of the pump.

This assembly achieves two objectives:
Preventing water from entering the concentrator if it has not been activated and able to deliver a slight pressure.
Ensuring that the pump is operating at its optimum flow rate before injecting a gas on the suction side of the water pump (to avoid the risk of cavitation).

This assembly ensures that no air is aspirated if the concentrator has not been activated.

In summary, as set out above, the gas from the concentrator is injected on the suction side of the pump, since a concentrator does not deliver enough pressure to be “mounted” on the discharge side of the pump (the pressure on the discharge side of the pump is typically between 1 bar and 8 bar).

According to an advantageous embodiment of the invention, two gas circuits are used to optimize operation of the facility:
a circuit supplied by the concentrator supplying the upstream (suction) side of the pump; and
a circuit supplied by a cylinder of oxygen or of a gas mixture containing oxygen, preferably bringing the gas to the discharge side of the pump (although injection on the suction side is possible).

This implementation is particularly advantageous in the following cases:
when the concentrator fails, or requires preventive maintenance.
when the need to dissolve gas in the water exceeds the capacity of the pump (risk of cavitation), gas can then be added, notably to the discharge side of the pump, via one or more gas cylinders equipped with a pressure-reducing valve at a pressure greater than the discharge pressure of the pump in question.

According to an advantageous embodiment of the invention, when such “emergency” cylinders are present, a shut-off valve is provided to switch between different operating modes:
implementation of the generator only;
implementation of one (or more) gas cylinders only;
implementation of both sources: generator and gas cylinder.

The following question then arises: can the “emergency” gas inlet be installed on the suction side of the pump? Such an arrangement, while perfectly feasible, does not appear to be advantageous, simply because the fact of having to lower the pressure of the gas to a pressure close to atmospheric pressure requires expensive equipment, but also because this avoids the risk of sending pressure into the circuit of the concentrator.

The appended FIG. 3 is a partial schematic view of an embodiment of the invention.

The nomenclature of the means in the facility illustrated in FIG. 3 is as follows:
1: gas cylinder
2: gas pressure-reducing valve (expanding the gas at a pressure higher than the pressure of the water network)
3: suction-side flowmeter (for regulating the oxygen flow on the suction side of the pump 9)
4: discharge-side flowmeter (for regulating the oxygen flow on the discharge side of the pump 9)
5: suction-side solenoid valve (controlled by activation of the pump and by a flow sensor)
6: discharge-side solenoid valve (controlled by activation of the pump and by flow sensor and by level switch with time delay)
7: suction-side Venturi (for injecting gas at a low flow rate into the water on the suction side of the pump without causing cavitation)
8: discharge-side Venturi (for injecting gas into the water on the discharge side of the pump, at the flow rate corresponding to the water supplementing the suction flow)
9: pump (for increasing the pressure of the water and creating a water flow, preferably between 1 m/s and 2.5 m/s).
10: coil (for dissolving the oxygen in the water, with a water flow rate preferably between 1 m/s and 2.5 m/s and a contact time preferably between 10 and 20 seconds)
11: water inlet solenoid valve (for maintaining the water level in the tank and activating the oxygen injection by actuating the reference sign 6)
12: backpressure regulator (for maintaining the water flow rate and therefore the speed in the coil, thereby supplying the desired outlet pressure to the user site)
13: solenoid valve (normally open (NO), for bypassing the system if the pump or control system stops, thereby ensuring that the animals always have water)
14: level switch (for managing the water level in the tank and triggering the high-flow oxygen injection, reference sign 6)
15: water flow regulator, regulating the inlet flow of new water
16: filter
17: water tank
20: fresh water inlet
30: recirculation/bypass
40: water network at the farm
50: watering stations (nipples)
60: generator (concentrator)
70: cylinder of oxygen or of a gas mixture containing oxygen
80: flow sensor
90: pressure sensor

Practical implementation tests of the present invention (injection on the suction side of the pump, at a location where the pressure is lower than the pressure of the oxygen generator, waiting for the pressure of the pump to rise before injecting oxygen or the gas containing oxygen) were performed under the following conditions:
A flow rate of 1.5 L/min of gas appeared sufficient to meet the demand at a chicken farm, with a consumption rate of 5 L/min of water, i.e. 300 L/h*20 h=6000 L/day (i.e. the maximum consumption of one building).
It takes 20 minutes to bring water at equilibrium (in air) to 30 mg/l of oxygen.
the generator operated stably for several hours at a consumption of 300 L/h, the content in the equipment remained stable, allowing this test to be validated.

The present invention therefore relates to a facility for the oxygen-doping of water used to irrigate crops or to water animals, comprising means for conveying water to the animals for watering or to said crops, said conveyance means comprising:
an injector for injecting a gas into water;
a water inlet line and at least one gas inlet line entering the injector; and
at least one source of oxygen or of a gas mixture including oxygen, capable of delivering oxygen into the gas line,
a tank of water at atmospheric pressure, the injector being supplied with water from the water in this tank, wherein said tank can furthermore be supplied with new water;
a coil capable of receiving water charged with dissolved oxygen coming from the injector, wherein said water arrives at the coil by virtue of a pump, and said coil creates a water/oxygen contact time;
the water coming out of the coil passing through a device such as a backpressure regulator so that it can be directed in full to the watering zone or the crops or else partly to the watering zone or the crops and partly to the tank;
   where the facility comprises means for injecting oxygen or a mixture including oxygen into the water from said source, the injection being carried out upstream of the pump (suction side), and where said source is an oxygen concentrator supplying oxygen-enriched air;
characterized in that the facility includes a water pressure sensor downstream (discharge side) of the pump, as well as a water flow sensor, preferably installed on the discharge side of the pump, enabling operation as follows:
   When the pump is started, the flow sensor authorizes the concentrator to be activated electrically;
   The pressure at the outlet of the pump then rises to its working pressure and when the pressure at the outlet of the pump rises to a desired pressure setpoint, the pressure sensor then authorizes the opening of a solenoid valve located between the concentrator and the suction side of the pump.

According to one of the embodiments of the invention, the facility comprises, in addition to said concentrator, another oxygen source consisting of one or more cylinders of oxygen or of a gas mixture including oxygen, enabling gas to be injected on the suction side or the discharge side of the pump, and means such as a shut-off valve are provided to switch between the following different operating modes:
implementation of the generator only;
implementation of the gas cylinder (or cylinders) only;
implementation of both sources: generator and gas cylinder.

Reference herein to “one embodiment” or “an embodiment” means that a particular feature, structure, or characteristic described in connection with the embodiment may be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The singular forms “a”, “an” and “the” include plural referents, unless the context clearly dictates otherwise.

“About” or “around” or “approximately” in the text or in a claim means ±10% of the value stated.

As used herein, “room temperature” in the text or in a claim means from approximately 20° C. to approximately 30° C.

The term “ambient temperature” refers to an environment temperature approximately 20° C. to approximately 30° C.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

Ranges may be expressed herein as from about one particular value, and/or to about another particular value. When such a range is expressed, it is to be understood that another embodiment is from the one particular value and/or to the other particular value, along with all combinations within said range. Any and all ranges recited herein are inclusive of their endpoints (i.e., x=1 to 4 or x ranges from 1 to 4 includes x=1, x=4, and x=any number in between), irrespective of whether the term “inclusively” is used.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

While embodiments of this invention have been shown and described, modifications thereof may be made by one skilled in the art without departing from the spirit or teaching of this invention. The embodiments described herein are exemplary only and not limiting. Many variations and modifications of the composition and method are possible and within the scope of the invention. Accordingly, the scope of protection is not limited to the embodiments described herein, but is only limited by the claims which follow, the scope of which shall include all equivalents of the subject matter of the claims.

What is claimed is:

1. A facility for oxygen-doping of water used to irrigate crops or to water animals (50), comprising means for conveying water to the animals for watering or to the crops, the conveyance means comprising:
an injector (7, 8) for injecting a gas into water;
a water inlet line (20) and at least one gas inlet line (3, 4, 5, 6) entering the injector; and
at least one source (1, 60) of oxygen or of a gas mixture including oxygen, capable of delivering oxygen into the gas line,
a tank (17) of water at atmospheric pressure, the injector being supplied with water from the water in this tank, wherein the tank is furthermore supplied with new water (20);
a coil (10) capable of receiving water charged with dissolved oxygen coming from the injector, wherein the water arrives at the coil by virtue of a pump (9), and the coil creates a water/oxygen contact time; and
the water coming out of the coil passing through a device so that it can be directed in full to the watering zone or the crops or else partly to the watering zone or the crops and partly to the tank (17);
wherein the facility comprises means for injecting oxygen or a mixture including oxygen into the water upstream of the pump, and where the source is an oxygen concentrator (60) supplying oxygen-enriched air;
wherein the facility includes a water pressure sensor (90) downstream (discharge side) of the pump, as well as a water flow sensor (80), preferably installed on the discharge side of the pump, enabling operation as follows:
when the pump is started, the flow sensor authorizes the concentrator to be activated electrically;
the pressure at the outlet of the pump then rises to its working pressure and when the pressure at the outlet of the pump rises to a desired pressure setpoint, the pressure sensor then authorizes the opening of a solenoid valve (5) located between the concentrator and the suction side of the pump.

2. The facility according to claim 1, further comprising, in addition to the concentrator (60), another oxygen source consisting of one or more cylinders (70) of oxygen or of a gas mixture including oxygen, enabling gas to be injected on the suction side or the discharge side of the pump, and in that means a shut-off valve is provided to switch between the following different operating modes:
implementation of the generator only;
implementation of the gas cylinder only;
implementation of both sources: generator and gas cylinder.

3. A method for oxygen-doping of water used to irrigate crops or to water animals (50), the method using a facility which comprises means for conveying water to the crops or animals for watering, the conveyance means comprising:
an injector (7, 8) for injecting a gas into water;
a water inlet line (20) and at least one gas inlet line (3, 4, 5, 6) entering the injector; and
at least one source (1, 60) of oxygen or of a gas mixture including oxygen, capable of delivering oxygen into the gas line,
a tank (17) of water at atmospheric pressure, the injector being supplied with water from the water in this tank, wherein the tank can furthermore be supplied with new water (20);
a coil (10) capable of receiving water charged with dissolved oxygen coming from the injector, wherein the water arrives at the coil by virtue of a pump (9), and the coil creates a water/oxygen contact time;
the water coming out of the coil passing through a device so that it is directed in full to the watering zone or the crops or else partly to the watering zone or the crops and partly to the tank (17);
wherein the facility comprises means for injecting oxygen or a mixture including oxygen into the water upstream of the pump, and where the source is an oxygen concentrator (60) supplying oxygen-enriched air;
being characterized by the implementation of the following measures:
the facility includes a water pressure sensor (90) downstream (discharge side) of the pump, as well as a water flow sensor (80), preferably installed on the discharge side of the pump;
electrical activation of the concentrator is authorized when the flow sensor detects that the pump has been started;
the pressure at the outlet of the pump then rises to its working pressure and when the pressure at the outlet of the pump rises to a desired pressure setpoint, the pressure sensor is then used to authorize the opening of a solenoid valve (5) located between the concentrator and the suction side of the pump.

4. The facility according to claim 1, wherein the device is a backpressure regulator (12).

5. The method according to claim 3, wherein the device is a backpressure regulator (12).
